(19) United States
(12) Patent Application Publication
(10) Pub. No.: US 2021/0045299 A1
(43) Pub. Date: Feb. 18, 2021

(54) PLANT GROWTH MEDIA COMPOSITIONS AND PRODUCTION PROCESSES THEREOF

(71) Applicant: Doug Ranno, Salinas, CA (US)

(72) Inventor: Doug Ranno, Salinas, CA (US)

(21) Appl. No.: 16/540,981

(22) Filed: Aug. 14, 2019

(51) Int. Cl. A01G 24/25; C05F 11/02; C05G 3/04; A01G 24/44; A01G 24/15; A01G 24/13

(52) U.S. Cl. CPC A01G 24/25; C05F 11/02; A01G 24/13; A01G 24/44; A01G 24/15; C05G 3/04

(57) ABSTRACT

A plant growth medium composition and production process thereof is provided. The growth medium composition comprises a coconut coir pith and one or more additives mixed into the coconut coir pith processed into a formed growth medium suitable for facilitating the growth of one or more plants. The production process comprises the steps of cracking, dehusking, and removing the meat from the whole coconut. The coconut coir is then washed and mulched, and an additive mixture is mixed with the coconut coir pith. The coconut coir pith and additive mixture is processed into a desired form, and the additive mixture is applied to the exterior surface thereof. The final product is then packaged before being transported to a horticulturist.

### TECHNICAL FIELD

The embodiments generally relate to plant growing mediums and nutrient compositions as well as processes of making the same.

### BACKGROUND

Soil mixtures have been used for growing plants for thousands of years. Many soil mixtures are optimized with nutrients to provide favorable growing conditions throughout a plant's growth cycle.

A wide variety of plant growth mediums are currently employed in various agricultural settings including sphagnum moss peat pots, composted hardwood bark, composted manure, foam plastic material, compressed spun basalt, and pots filled with perlite, vermiculite, or expanded clay. Each growth medium has drawbacks due to the contents of the utilized medium. For example, peat has a high tannin content, while the spun basalt and plastics are unpleasant to handle and are often expensive. Compressed growth media helps in providing an easy mode for transporting the composition while effectively preventing water intrusion or germination of the seeds.

Coconut coir pith is a by-product of the coconut husk fiber processing industry. Coir is the name given to the fibrous material that constitutes the mesocarp of the coconut fruit produced by the Cocos nucifera. The coconut coir pith provides an excellent growth medium due to its lack of extraneous growth material, offering an advantageous alternative to sphagnum.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein provide a plant growth medium composition and production process thereof. The growing medium comprises a coconut coir pith and one or more additives mixed into the coconut coir pith which is processed into a formed growth medium suitable for facilitating the growth of one or more plants.

In one aspect, the additives are comprised of one or more of the following: zeolite, limestone, limerock, calcium carbonate, attapulgite, coral, marble, bentonite clay, fillers earth, nitrogen cake, kaolin, bauxite, alumina trihydrate, aluminum oxide, and titanium dioxide.

In one aspect, the coconut coir pith and additive mixture is provided with a suitable amount of heat and pressure to form the coconut coir pith and additive mixture into a shape selected by the grower or retailer.

In one aspect, the one or more additives are applied to an exterior surface of the coconut coir pith and additive mixture.

In one aspect, the coconut coir pith and additive mixture is provided with a packaging having a handle. In some embodiments, the packaging may contain structural support members such as a ribbed support strap to reduce the likelihood of breakage during transportation of the product.

A production process for producing a plant growing medium is disclosed. A plurality of coconuts are sourced, cracked, and dehusked to remove the meat from the interior of the coconut. The de-husked coconuts are then washed and mulched to produce the coconut coir pith. One or more additives are then added to the coconut coir pith based on grower or retailer specifications. Heat and pressure are applied to the coconut coir pith and additive mixture to form a shape. Once the shape is formed, the additive mixture is then further applied to the exterior of the processed coconut coir pith and additive mixture, which may then be packaged before delivery to the consumer.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the coconut coir pith and additive mixture, according to some embodiments;

FIG. 2 illustrates an alternate perspective view of the coconut coir pith and additive mixture, according to some embodiments;

FIG. 3 illustrates a further perspective view of the coconut coir pith and additive mixture, according to some embodiments;

FIG. 4 illustrates a perspective view of the packaging configured to contain the coconut coir pith and additive mixture during shipping and handling processes, according to some embodiments; and

FIG. 5 illustrates a flowchart of a production process for the coconut coir pith and additive mixture, according to some embodiments.

### DETAILED DESCRIPTION

The specific details of the single embodiment or variety of embodiments described herein are to the described composition and production processes thereof. Any specific details of the embodiments are used for demonstration purposes only, and no unnecessary limitations or inferences are to be understood therefrom.

Before describing in detail exemplary embodiments, it is noted that the embodiments reside primarily in combinations of components of the composition and the production process thereof. Accordingly, the components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments disclosed herein relate to plant growth media having additives to facilitate the entire growth cycle of the plant. The growth medium composition is a mixture of coconut coir pith and plant nutrients which is formed into various shapes, sizes, and configurations described herein. The embodiments also relate to a production process for the growth medium and additive mixture.

The coconut coir pith has various benefits as a growth medium. It increases the organic matter content of the soil, and due to its high lignin to cellulose ratio, it remains in the soil significantly longer than peat compositions. The coconut coir pith also improves water-holding capacity over many soil types while promoting adequate drainage if overwatered.

As used herein, the term “coconut coir pith” is intended to refer to both the coconut husk pith and the short coir fibers which are known to provide an excellent growing medium and to provide a suitable and sustainable substitute for soilless growing media such as peat moss (sphagnum, sedge, hypnum and the like) for growing plants. Coconut coir pith has many physical and horticultural characteristics that make it an ideal growing medium for plants. Coconut coir pith has a high water holding capacity, ideal porosity, high cation exchange capacity, and high stability (slow rate of degradation due to high lignin to cellulose ratio, which prevents oxidation).

The coconut coir pith may be processed into various forms including flakes, particles, pellets, slurries, or otherwise processed into a usable form. As used herein, the term “granules” is intended to include all granular forms and shapes, including flakes, particles, pellets, slurries, and the like. The coconut coir pith may be mixed with a suitable percentage by weight of horticulturally acceptable organic or non-organic media such as sphagnum peat, humus peat, sedge peat, bark, rice hulls, and any other material and/or mixtures thereof which are known to those skilled in the arts.

As used herein, the term “additive(s)” relates to any substance added to the coconut coir pith such as fertilizers, micronutrients, pH adjusting agents such as lime, pesticides, herbicides, and/or various wetting agents including horticulturally acceptable surfactants and other additives designed to enhance or protect germination, development, and/or growth of seeds and plants implanted in the growth medium described in the various embodiments herein.

In some embodiments, the additives may include horticulturally acceptable amounts of zeolite, lime (including limestone and limerock), calcium carbonate, attapulgite, coral, marble, bentonite clay, fillers earth, nitrogen cake, kaolin, bauxite, alumina trihydrate, aluminum oxide, titanium dioxide, and any other organic or non-organic mineral, soil, or soil additive product. One skilled in the arts of horticulture will understand that various other additives may be implemented in the plant growth medium.

Some additional additives may include but are not limited to apatite, clays (hydrated aluminum silicates, coal, aluminum oxide, diatomaceous earth, erionite, feldspar, flint, calcium fluoride, granite, hydrated calcium sulfate, mica, pumice, sandstone, silica, slate, talc, and calcium silicate.

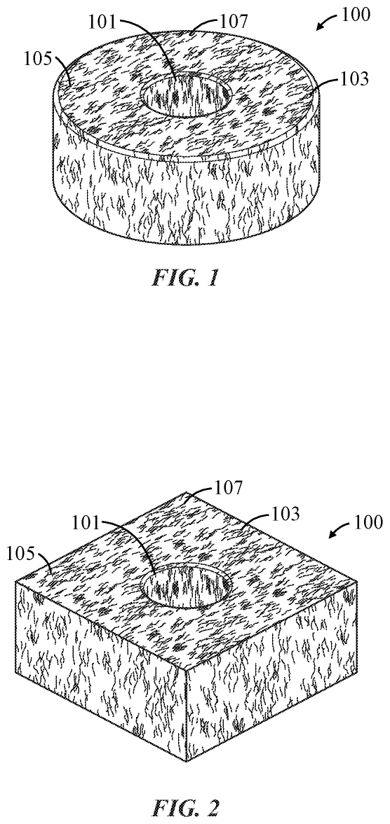

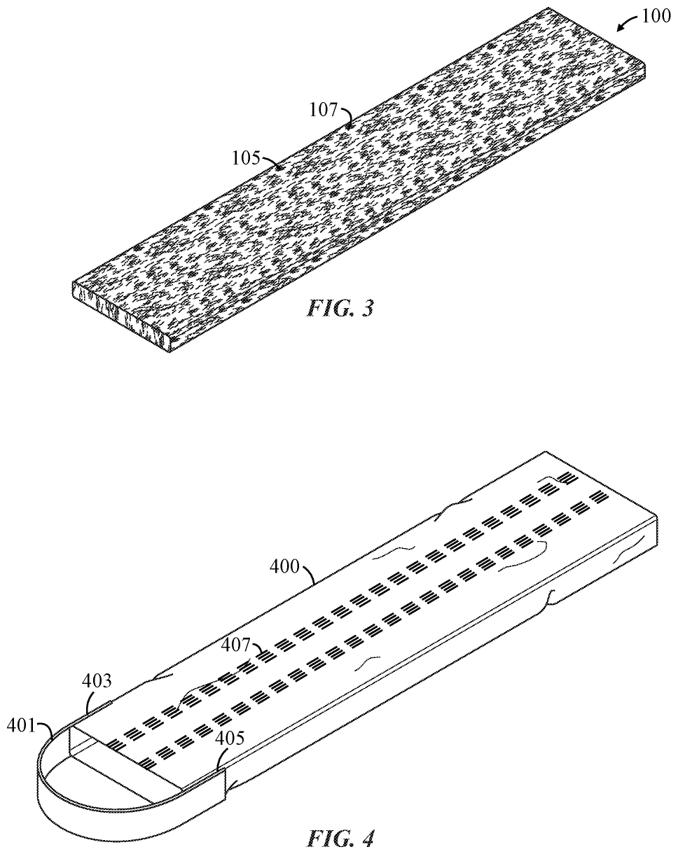

In reference to FIGS. 1-3, the processed coconut coir pith and additive mixture 100 is illustrated in exemplary embodiments. Specifically, FIG. 1 illustrates a cylindrical shape of the coconut coir pith and additive mixture 100 formed during the production process. FIG. 2 illustrates a cuboid shape of the coconut coir pith and additive mixture 100 formed during the production process. FIG. 3 illustrates a further cuboid shape of the coconut coir pith and additive mixture 100 formed during the production process. One skilled in the arts will readily understand that the shape, size, and configuration of the coconut coir pith and additive mixture may be readily changed with deterring from the embodiments provided herein. The processed coconut coir pith and additive mixture 100 may be provided with one or more apertures 101 on a top side 103 to receive and facilitate the growth of a plant or seed thereof. A coating of an additive composition 105 may be applied to the surface 107 of the processed coconut coir pith and additive mixture 100 during the production process to facilitate the growth of the plant.

In some embodiments, the additive mixture provided to the surface of the processed coconut coir pith and additive mixture may be the same as, or may differ from the additive mixture mixed with the coconut coir pith. The selection of the composition and amounts of the processed coconut coir pith and additive mixture 100 may be determined by the consumer, grower, or retailer.

FIG. 4 illustrates the packaging 400, which is configured to receive the processed coconut coir pith and additive mixture 100 prior to shipping and handling. The packaging 400 is provided with a handle 401 attached on a first side 403 and a second side 405 to allow a user to carry the fragile processed coconut coir pith and additive mixture 100 via the packaging and reduce the likelihood of damage during transport. In some embodiments, the packaging 400 may include one or more support members 407 which strengthen the length of the packaging 400 to support the processed coconut coir pith and additive mixture 100 during transportation, especially if carried along its length.

In some embodiments, one or more support members 407 are provided on one or more sides of the packaging to reinforce the packaging and prevent breakage of the formed coconut coir pith and additive mixture. In some embodiments, the one or more support members 407 may be provided with an adhesive to facilitate attachment to the surface of the packaging.

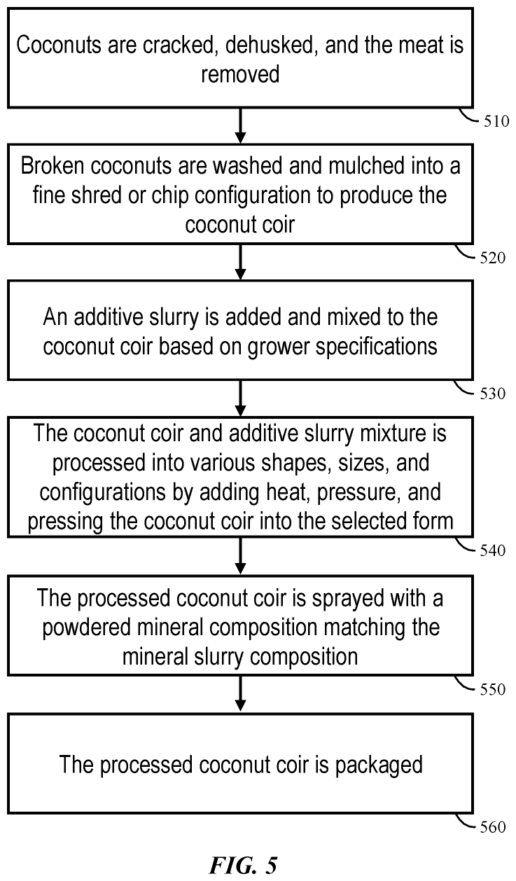

In reference to FIG. 5, a flowchart is illustrated for the growth media production process. In step 510, coconuts are sourced before being cracked, to remove the meat therein. In step 520, the coconut coir is then washed and mulched, shredded, or made into a chip form. One skilled in the arts will understand that various other processes may be performed to break down the coconut into a usable form. In step 530, an additive slurry is combined with the processed coconut coir based on consumer requirements and plant growth specifications. For example, the consumer may specify nutrient percentages-by-weight required for one or more nutrients to be mixed with the coconut coir. In step 540, the coconut coir and additive slurry mixture are processed into various shapes, sizes, and configurations by adding heat and temperature to a press formed to mold the coconut coir pith and additive mixture 100 into the consumer-specified form. In step 550, a powdered additive composition is applied to the exterior surface of the processed coconut coir pith and additive mixture. The powdered additive may be sprayed, or otherwise applied to the exterior surface. Further, the applied additive may match the composition added to the coconut coir in step 530 or may be a different composition of additives depending on the request of the consumer. In step 560, the final composition is then packaged and supplied to the end consumer.

In some embodiments, formed coconut coir pith and additive mixture 100 is provided with one or more apertures 101 to receive a plant and facilitate the growth thereof. The apertures 101 may be formed into one or more surfaces of the formed coconut coir pith and additive mixture 100.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A growing medium composition for plants, comprising:
a coconut coir pith; and
one or more additives mixed into the coconut coir pith processed into a formed growth medium suitable for facilitating the growth of one or more plants.

2. The growth medium composition of claim 1, wherein the one or more additives are comprised of one or more of the following: zeolite, limestone, limerock, calcium carbonate, attapulgite, coral, marble, bentonite clay, fillers earth, nitrogen cake, kaolin, bauxite, alumina trihydrate, aluminum oxide, and titanium dioxide.

3. The growth medium composition of claim 1, wherein the coconut coir pith and additive mixture is provided with heat and pressure to form the coconut coir pith and additive mixture into a shape.

4. The growth medium composition of claim 1, wherein the one or more additives are applied to a surface of the coconut coir pith and additive mixture.

5. The growth medium composition of claim 1, wherein the growth medium and additive mixture is disposed in a packaging.

6. The growth medium composition of claim 5, wherein the packaging is comprised of one or more structural members to prevent breakage of the coconut coir pith and additive mixture during transport.

7. The growth medium composition of claim 1, wherein the processed coconut coir pith and additive mixture is provided with one or more apertures wherein a plant is disposed, wherein the apertures facilitate the growth of the plant.

8. A production process for a plant growing medium, the production process comprising:
cracking a plurality of coconuts;
dehusking the plurality of cracked coconuts;
removing the meat from the plurality of cracked and de-husked coconuts;
washing and mulching the plurality of cracked and de-husked coconuts to produce a coconut coir pith;
adding an additive mixture to the coconut coir pith;
processing the coconut coir pith and additive mixture;
applying the additive mixture to an exterior surface of the processed coconut coir pith and additive mixture; and
packaging the coconut coir pith and additive mixture.

9. The production process of claim 8, wherein the one or more additives are comprised of one or more of the following: zeolite, limestone, limerock, calcium carbonate, attapulgite, coral, marble, bentonite clay, fillers earth, nitrogen cake, kaolin, bauxite, alumina trihydrate, aluminum oxide, and titanium dioxide.

10. The production process of claim 9, wherein the step of processing the coconut coir and additive mixture comprises forming the coconut coir and additive mixture into a shape.

11. The production process of claim 10, further comprising the step of providing the coconut coir pith and additive mixture with one or more apertures.

12. The production process of claim 11, further comprising the step of providing a plant to the formed coconut coir and additive mixture to promote the growth of the plant, wherein one of the one or more apertures receives the plant.

13. The production process of claim 8, wherein the growth medium and additive mixture is disposed in a packaging.

14. The production process of claim 13, wherein the packaging is comprised of one or more structural members to prevent breakage of the coconut coir pith and additive mixture during shipping and handling.

15. The production process of claim 14, wherein the packaging includes a handle.

16. A growing medium composition for plants, comprising:
a coconut coir pith and one or more additives mixed into the coconut coir pith to produce a coconut coir pith and additive mixture including a top surface including one or more apertures to each receive and facilitate the growth of a plant; and
a packaging to at least partially receive the coconut coir pith and additive mixture.

17. The production process of claim 16, wherein the one or more additives are comprised of one or more of the following: zeolite, limestone, limerock, calcium carbonate, attapulgite, coral, marble, bentonite clay, fillers earth, nitrogen cake, kaolin, bauxite, alumina trihydrate, aluminum oxide, and titanium dioxide.

18. The growth medium composition of claim 17, wherein the one or more additives are applied to a surface of the coconut coir pith and additive mixture.

19. The growth medium composition of claim 16, wherein the packaging is comprised of one or more structural members to prevent breakage of the coconut coir pith and additive mixture during shipping and handling.

20. The growth medium composition of claim 19, wherein the packaging is comprised of a handle.
